(19) United States
(12) Patent Application Publication
(10) Pub. No.: US 2008/0134267 A1
(43) Pub. Date: Jun. 5, 2008

(54) Remote Access to Internet Protocol Television by Enabling Place Shifting Utilizing a Telephone Company Network

(75) Inventors: DHAWAL BALKRISHNA MOGHE, PLANO, TX (US); FREDERICK H. SKOOG, COLLEYVILLE, TX (US)

Correspondence Address: ALCATEL LUCENT;INTELLECTUAL PROPERTY & STANDARDS, 3400 W. PLANO PARKWAY, MS LEGL2, PLANO, TX, 75075, US

(73) Assignee: ALCATEL LUCENT, Paris (FR)

(21) Appl. No.: 11/566,368

(22) Filed: Dec. 4, 2006

(51) Int. Cl. H04N 7/173

(52) U.S. Cl. 725/112

(57) ABSTRACT

A system, method, and computer readable medium for remote access to Internet Protocol television by enabling place shifting utilizing a telephone company network, that comprises, confirming an identity of a remote Internet Protocol enabled device, managing a rate of a data stream to the remote Internet Protocol enabled device based upon the confirmed identity, and transmitting the data stream to the remote Internet Protocol enabled device utilizing a broadband network.

### BACKGROUND OF THE INVENTION

The present invention is generally related to Internet Protocol Television (IPTV) distribution and, more specifically to remote access to internet protocol television by enabling place shifting utilizing a telephone company network.

Currently, subscribers may remotely access Internet Protocol Television (IPTV) services, which are subscribed to at his home from a broadband location in a hotel room or a public place outside the subscriber's home. This place shifting or TV anywhere concept is analogous to the time shifting functionality provided by the Video Cassette Recorder (VCR), or the Digital Video Recorder (DVR) boxes available today. However the video quality of the signal is poor due to bandwidth limitations.

Currently, devices can enable a subscriber to watch his living room television programming from a remote location by utilizing an Internet-connected laptop or Personal Computer (PC). These devices place shift the television signal from a subscriber's cable box, satellite receiver, or DVR to a PC via the Internet. Wherever the subscriber goes, the poor video quality TV will follow. The video quality provided by the existing solution is poor because the bandwidth of the upstream channel and the encoder for the existing solution is typically limited to 256 Kbps.

Therefore, what is needed is a method, computer readable medium and system for allowing place shifting of a high quality IPTV signal to the customer utilizing a telephone company network.

### SUMMARY OF THE INVENTION

The current invention utilizes the telephone network to send a high quality signal to the remote PC or the laptop. The Digital Rights Management (DRM) system in the remote PC will communicate with the network and the home set top box to confirm the identity of the remote PC before the content can be transmitted to or played on the remote PC.

The video stream will be transmitted to the remote PC after confirming the identity of the remote PC connected in a broadband network. For Video on Demand (VOD) movies the system will have the ability to buffer a part of the movie in the remote PC to make the system more robust and less susceptible to transmission problems. The laptop can also serve as a distributed network Personal Video Recorder (PVR) by storing short segments of the various movies or programs which can be linked to the Network PVR device to improve the response time and the variety of programming available in video capacity constrained remote video player or laptop.

Higher quality of video reception at the remote location can be achieved by enabling the telephone network to transmit the higher quality video signal to the remote PC. Transmission bandwidth of several Mbps can be achieved as compared to a fraction of an Mbps bandwidth and the lower quality available in the current system. Local storage of short segments of program of regular interest can improve both the response time and the programming variety and selection in the remote device.

In one embodiment of the present invention, a method for remote access to Internet Protocol television by enabling place shifting utilizing a telephone company network, that comprises, confirming an identity of a remote Internet Protocol enabled device, managing a rate of a data stream to the remote Internet Protocol enabled device based upon the confirmed identity, and transmitting the data stream to the remote Internet Protocol enabled device utilizing a broadband network. The method may also comprise sensing an optimal resolution of the internet protocol enabled device, wherein the rate is managed according to the sensed optimal resolution, sending the sensed optimal resolution to the broadband network and buffering the data stream in the remote Internet Protocol enabled device. Wherein the confirmation of identity of the remote Internet Protocol enabled device utilizes digital rights management protocols and wherein the confirmation of identity of the remote Internet protocol enabled device is performed by the broadband network. The method may additionally comprise transmitting a validation query from the remote Internet Protocol enabled device to the broadband network, sending a set of user preferences of the remote Internet Protocol enabled device to the broadband network and storing a set of user preferences in the remote Internet Protocol enabled device.

In a further embodiment of the present invention, a computer readable medium comprises instructions for, receiving a validation query at a set top box from a remote Internet Protocol enabled device, confirming an identity of the remote Internet Protocol enabled device, managing a rate of a data stream to the remote Internet Protocol enabled device based upon the confirmed identity, and transmitting the data stream from the set top box to the remote Internet Protocol enabled device utilizing a broadband network. The computer readable medium may comprise instructions for buffering the data stream in the remote Internet Protocol enabled device, sending a set of user preferences from the set top box to the remote Internet Protocol enabled device, sending a set of user preferences from the set top box to the broadband network, storing a set of user preferences in the remote Internet Protocol enabled device and storing a set of user preferences in the broadband network.

In yet a further embodiment, a system for remote access to Internet Protocol television by enabling place shifting utilizing a telephone company network comprises a memory that receives a data stream, and a processor communicably coupled to the memory, wherein the processor, sends a validation query from a remote Internet Protocol enabled device to a set top box, receives the data stream at the remote Internet Protocol enabled device from the set top box utilizing a broadband network, manages a rate of the data stream to the remote Internet Protocol enabled device based upon the validation query, and buffers the data stream in the remote Internet Protocol enabled device. The system processor may receive a set of user preferences at the remote Internet Protocol enabled device from the set top box and store a set of user preferences in the remote Internet Protocol enabled device, wherein the broadband network is a telephone company network.

### BRIEF DESCRIPTION OF THE DRAWINGS

FIG. 1 illustrates a first system of intelligent IPTV program switching that includes an embodiment of the present invention as a portion thereof,

FIG. 2 illustrates a first method flow diagram listing the method steps of the method of operation of an embodiment of the present invention;

FIG. 3 illustrates a second method flow diagram listing the method steps of the method of operation of an embodiment of the present invention;

FIG. 4 illustrates a first software flow diagram of remote access to internet protocol television in accordance with an embodiment of the present invention;

FIG. 5 illustrates a second software flow diagram of remote access to internet protocol television in accordance with an embodiment of the present invention;

FIG. 6 illustrates a first system of remote access to internet protocol television by enabling place shifting utilizing a telephone company network in accordance with an embodiment of the present invention; and

FIG. 7 illustrates a second system of remote access to internet protocol television by enabling place shifting utilizing a telephone company network in accordance with an embodiment of the present invention.

### DETAILED DESCRIPTION OF THE INVENTION

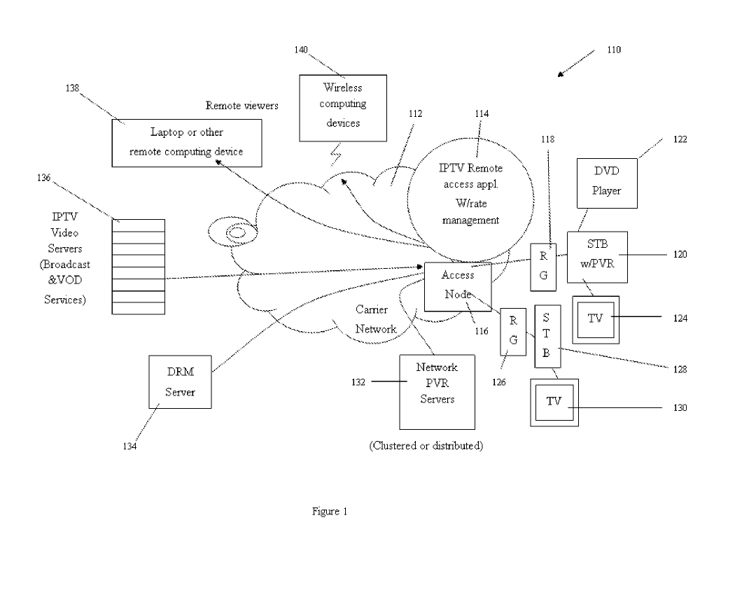

Referring now to FIG. 1, a first system of remote access to internet protocol television by enabling place shifting utilizing a telephone company network 110 is depicted and comprises a number of blocks or modules that are software, hardware, or firmware, and/or the combination of software, hardware, and/or firmware. A carrier network 112 is communicably coupled to an IPTV remote access application with rate management 114 having an access node 116. The access node is communicably coupled to a Residential Gateway (RG) 118, which in turn is communicably coupled to a Set Top Box (STB) 120. The set top box is connected to a DVD player 122 and a Television (TV) 124. The access node can be communicably coupled to another residential gateway 126 that is connected to a Set Top Box (STB) 128, which in turn is connected to another TV 130. The access node can additionally be connected to a network Personal Video Recorder (PVR) 132. The access node gathers information pertaining to legitimate digital rights from a Digital Rights Management (DRM) server 134. The access node can also be connected to IPTV video servers 136 which service broadcast and video on demand services. The carrier network can additionally service remote viewers such as a laptop or remote computer 138 or a wireless computing device 140.

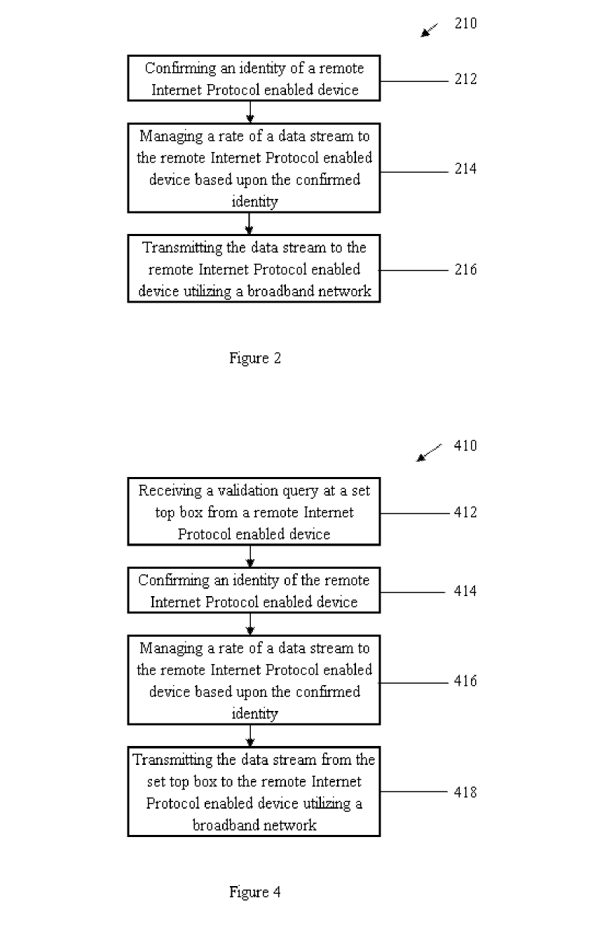

Referring now to FIG. 2, a first method of remote access to internet protocol television by enabling place shifting utilizing a telephone company network 210 is depicted and comprises a number of blocks or modules that are software, hardware, or firmware, and/or the combination of software, hardware, and/or firmware. The method comprises, confirming 212 an identity of a remote Internet Protocol enabled device, managing 214 a rate of a data stream to the remote Internet Protocol enabled device based upon the confirmed identity, and transmitting 216 the data stream to the remote Internet Protocol enabled device utilizing a broadband network. The transfer of information between the modules occurs via at least one of: a wireless protocol, a wired protocol and a combination of the wireless protocol and the wired protocol.

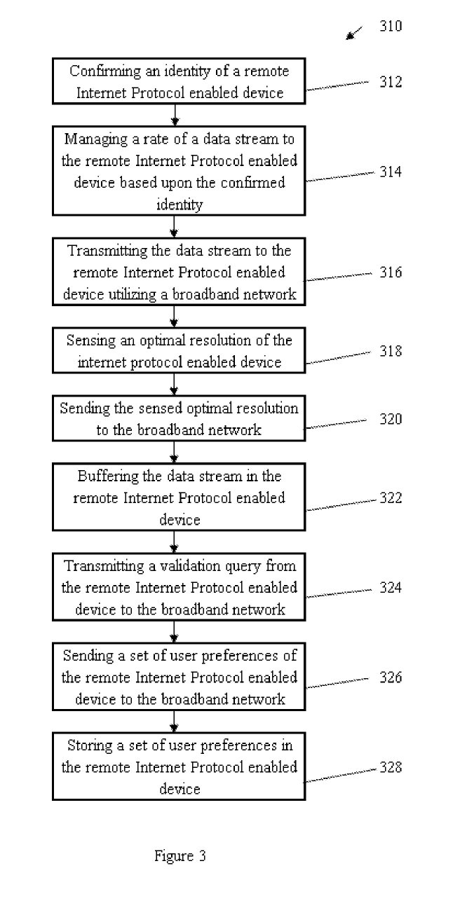

Referring now to FIG. 3, a second method of remote access to internet protocol television by enabling place shifting utilizing a telephone company network 310 is depicted and comprises a number of blocks or modules that are software, hardware, or firmware, and/or the combination of software, hardware, and/or firmware. The method comprises, confirming 312 an identity of a remote Internet Protocol enabled device, managing 314 a rate of a data stream to the remote Internet Protocol enabled device based upon the confirmed identity, and transmitting 316 the data stream to the remote Internet Protocol enabled device utilizing a broadband network. The method may also comprise sensing 318 an optimal resolution of the internet protocol enabled device, wherein the rate is managed according to the sensed optimal resolution, sending 320 the sensed optimal resolution to the broadband network and buffering 322 the data stream in the remote Internet Protocol enabled device. Wherein the confirmation of identity of the remote Internet Protocol enabled device utilizes digital rights management protocols and wherein the confirmation of identity of the remote Internet protocol enabled device is performed by the broadband network. The method may additionally comprise transmitting 324 a validation query from the remote Internet Protocol enabled device to the broadband network, sending 326 a set of user preferences of the remote Internet Protocol enabled device to the broadband network and storing 328 a set of user preferences in the remote Internet Protocol enabled device. The transfer of information between the modules occurs via at least one of: a wireless protocol, a wired protocol and a combination of the wireless protocol and the wired protocol.

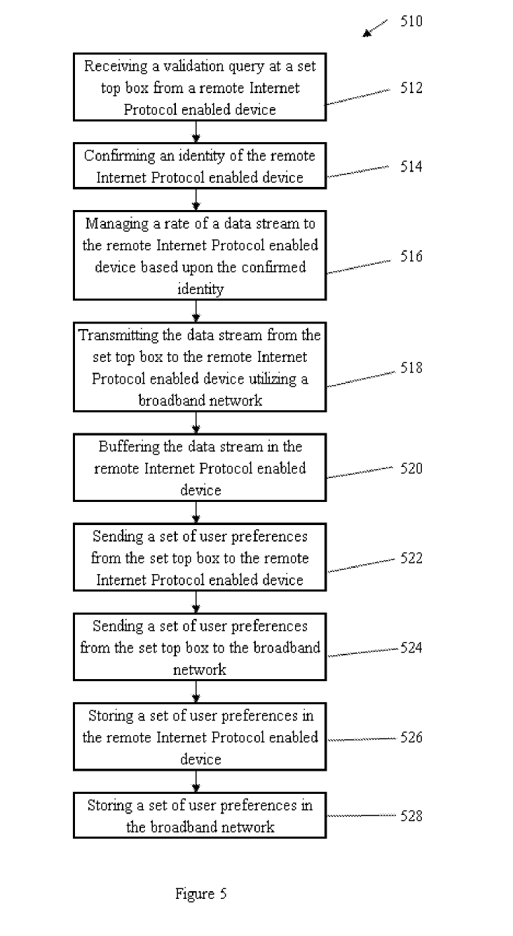

Referring now to FIG. 4, a first software flow block 410 of remote access to internet protocol television by enabling place shifting utilizing a telephone company network is depicted. A computer readable medium comprises instructions for, receiving 412 a validation query at a set top box from a remote Internet Protocol enabled device, confirming 414 an identity of the remote Internet Protocol enabled device, managing 416 a rate of a data stream to the remote Internet Protocol enabled device based upon the confirmed identity, and transmitting 418 the data stream from the set top box to the remote Internet Protocol enabled device utilizing a broadband network. The transfer of information between the repository and the monitor occurs via at least one of a wireless protocol, a wired protocol and the combination of the wireless protocol and the wired protocol.

Referring now to FIG. 5, a second software flow block 510 of remote access to internet protocol television by enabling place shifting utilizing a telephone company network is depicted. A computer readable medium comprises instructions for, receiving 512 a validation query at a set top box from a remote Internet Protocol enabled device, confirming 514 an identity of the remote Internet Protocol enabled device, managing 516 a rate of a data stream to the remote Internet Protocol enabled device based upon the confirmed identity, and transmitting 518 the data stream from the set top box to the remote Internet Protocol enabled device utilizing a broadband network. The computer readable medium may comprise instructions for buffering 520 the data stream in the remote Internet Protocol enabled device, sending 522 a set of user preferences from the set top box to the remote Internet Protocol enabled device, sending 524 a set of user preferences from the set top box to the broadband network, storing 526 a set of user preferences in the remote Internet Protocol enabled device and storing 528 a set of user preferences in the broadband network. This method is preferably embodied in a computer readable medium or software but may also be embodied in firmware and is utilized via hardware. The transfer of information between the repository and the monitor occurs via at least one of a wireless protocol, a wired protocol and the combination of the wireless protocol and the wired protocol.

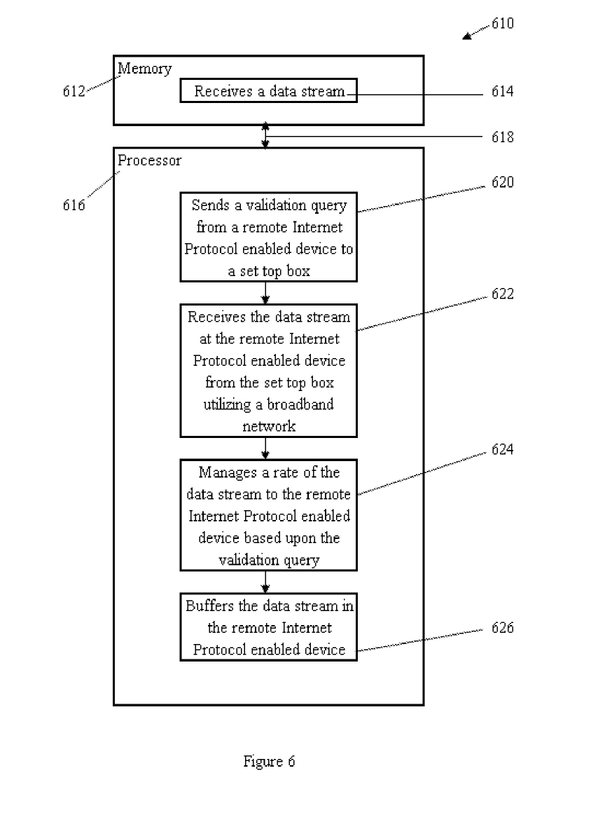

Referring now to FIG. 6, a first system 610 of remote access to internet protocol television by enabling place shifting utilizing a telephone company network is depicted. The system comprises a memory 612 that receives 614 a data stream, and a processor 616 communicably coupled 618 to the memory, wherein the processor, sends 620 a validation query from a remote Internet Protocol enabled device to a set top box, receives 622 the data stream at the remote Internet Protocol enabled device from the set top box utilizing a broadband network, manages 624 a rate of the data stream to the remote Internet Protocol enabled device based upon the validation query, and buffers 626 the data stream in the remote Internet Protocol enabled device. The transfer of information between the processor and the memory occurs via at least one of a wireless protocol, a wired protocol and a combination of a wireless protocol and a wired protocol. The steps performed in this figure are performed by software, hardware, firmware, and/or the combination of software, hardware, and/or firmware.

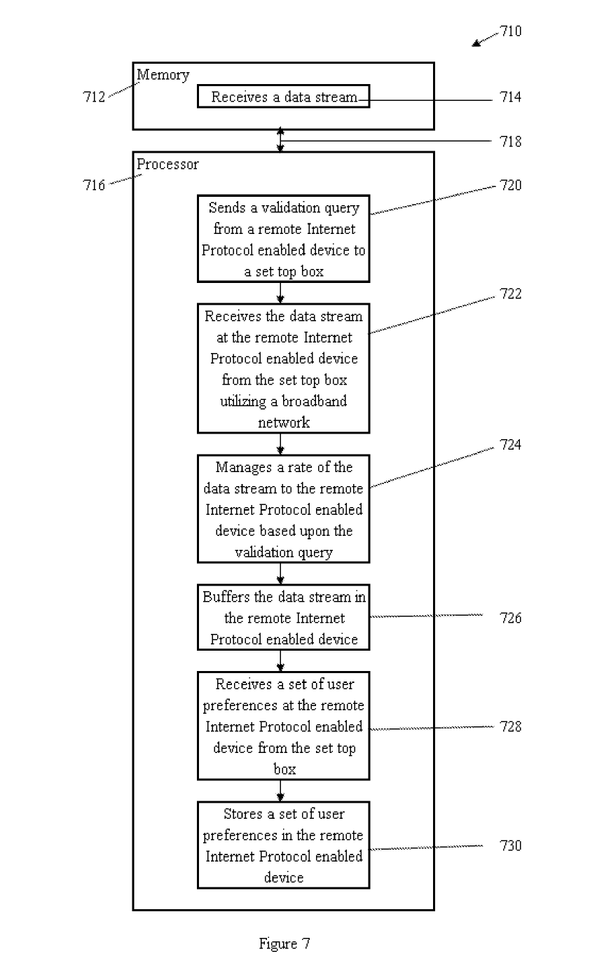

Referring now to FIG. 7, a second system 710 of remote access to internet protocol television by enabling place shifting utilizing a telephone company network is depicted. The system comprises a memory 712 that receives 714 a data stream, and a processor 716 communicably coupled 718 to the memory, wherein the processor, sends 720 a validation query from a remote Internet Protocol enabled device to a set top box, receives 722 the data stream at the remote Internet Protocol enabled device from the set top box utilizing a broadband network, manages 724 a rate of the data stream to the remote Internet Protocol enabled device based upon the validation query, and buffers 726 the data stream in the remote Internet Protocol enabled device. The system processor may receive 728 a set of user preferences at the remote Internet Protocol enabled device from the set top box and store 730 a set of user preferences in the remote Internet Protocol enabled device, wherein the broadband network is a telephone company network. The transfer of information between the processor and the memory occurs via at least one of a wireless protocol, a wired protocol and a combination of a wireless protocol and a wired protocol. The steps performed in this figure are performed by software, hardware, firmware, and/or the combination of software, hardware, and/or firmware.

Although an exemplary embodiment of the system of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. A method for remote access to Internet Protocol television by enabling place shifting utilizing a telephone company network, comprising:
confirming an identity of a remote Internet Protocol enabled device;
managing a rate of a data stream to the remote Internet Protocol enabled device based upon the confirmed identity; and
transmitting the data stream to the remote Internet Protocol enabled device utilizing a broadband network.

2. The method of claim 1 comprising:
sensing an optimal resolution of the internet protocol enabled device.

3. The method of claim 2 wherein the rate is managed according to the sensed optimal resolution.

4. The method of claim 2 comprising:
sending the sensed optimal resolution to the broadband network.

5. The method of claim 1 comprising:
buffering the data stream in the remote Internet Protocol enabled device.

6. The method of claim 1 wherein:
the confirmation of identity of the remote Internet Protocol enabled device utilizes digital rights management protocols.

7. The method of claim 1 wherein:
the confirmation of identity of the remote Internet protocol enabled device is performed by the broadband network.

8. The method of claim 1 comprising:
transmitting a validation query from the remote Internet Protocol enabled device to the broadband network.

9. The method of claim 1 comprising:
sending a set of user preferences of the remote Internet Protocol enabled device to the broadband network.

10. The method of claim 1 comprising:
storing a set of user preferences in the remote Internet Protocol enabled device.

11. A computer readable medium comprising instructions for:
receiving a validation query at a set top box from a remote Internet Protocol enabled device;
confirming an identity of the remote Internet Protocol enabled device;
managing a rate of a data stream to the remote Internet Protocol enabled device based upon the confirmed identity; and
transmitting the data stream from the set top box to the remote Internet Protocol enabled device utilizing a broadband network.

12. The method of claim 1 comprising instructions for:
buffering the data stream in the remote Internet Protocol enabled device.

13. The computer readable medium of claim 11 comprising instructions for:
sending a set of user preferences from the set top box to the remote Internet Protocol enabled device.

14. The computer readable medium of claim 11 comprising instructions for:
sending a set of user preferences from the set top box to the broadband network.

15. The computer readable medium of claim 11 comprising instructions for:
storing a set of user preferences in the remote Internet Protocol enabled device.

16. The computer readable medium of claim 11 comprising instructions for:
storing a set of user preferences in the broadband network.

17. A system for remote access to Internet Protocol television by enabling place shifting utilizing a telephone company network, comprising:
a memory that receives a data stream; and
a processor communicably coupled to the memory, wherein the processor:
sends a validation query from a remote Internet Protocol enabled device to a set top box;
receives the data stream at the remote Internet Protocol enabled device from the set top box utilizing a broadband network;
manages a rate of the data stream to the remote Internet Protocol enabled device based upon the validation query; and
buffers the data stream in the remote Internet Protocol enabled device.

18. The system of claim 17 wherein the processor receives a set of user preferences at the remote Internet Protocol enabled device from the set top box.

19. The system of claim 17 wherein the processor stores a set of user preferences in the remote Internet Protocol enabled device.

20. The system of claim 17 wherein the broadband network is a telephone company network.
